(19) United States
(12) Patent Application Publication
(10) Pub. No.: US 2021/0056575 A1
(43) Pub. Date: Feb. 25, 2021

(54) SYSTEM AND METHOD FOR EVALUATING MEDICAL EQUIPMENT

(71) Applicant: EquipX, LLC, Aventura, FL (US)

(72) Inventor: Ilan Mintz, Aventura, FL (US)

(21) Appl. No.: 17/000,267

(22) Filed: Aug. 21, 2020

Related U.S. Application Data
(60) Provisional application No. 62/889,966, filed on Aug. 21, 2019.

(51) Int. Cl. G06Q 30/02; G06Q 30/06; G06F 3/0481; G06F 9/451

(52) U.S. Cl. CPC G06Q 30/0206; G06Q 30/0283; G06F 9/451; G06F 3/0481; G06Q 30/0641

(57) ABSTRACT

System and method for evaluating medical equipment for market-place of used-medical equipment, for sales, sourcing, price discovery, budgeting analysis and value arbitrage, whereby the users interact as buyers and/or sellers and/or OEM manufactures. The pricing model is based on unlocking the cash value of depreciated medical equipment using a proprietary value and pricing analysis with algorithms, and thereby creating a virtual global e-marketplace for used or refurbished medical equipment with scheduled retirement dates. Algorithms analyze, calculate, compute and output data values by combining seller's data and external data such as but not limited to prior, current and future values, supply and demand, wear-and-tear, depreciation and transferable warrantees and service plans, expected lifespan, age of equipment, condition, cost to seller, manufacturers reputation and product pedigree, and a medical device value calculator, optimal point of core value sale, cost of use analysis, geographic location and transportation and logistics costs.

### RELATED APPLICATION

This application claims priority benefit of U.S. Provisional Application No. 62/889,966, filed Aug. 21, 2019, which is hereby incorporated by reference in its entirety.

### FIELD

The present disclosure generally relates to the medical field and, more particularly, to evaluation of medical equipment.

### DESCRIPTION OF THE RELATED ART

Pre-owned or used medical equipment is an often-overlooked asset in a hospital or medical practice. Generally, decisions regarding capital spending on medical equipment are normally made by consensus of a committee, based on historical trends, rather than forecasting for future needs. The medical equipment of a medical facility is generally counted as an expense, and its value is indicated only by its depreciated value in the accounting ledger, rather than its value in the used market place.

Most health systems do not know the operating costs, revenue, utilization and profitability of their capital equipment. The lack of metrics (e.g., profit and loss) for capital equipment means that clinical service line leaders have no visibility into the contribution they make to the health system's profitability. The depreciated book values of a health system's most expensive equipment typically represent only 70% of current market value.

What is needed is a system and method for evaluating medical equipment enabling better evaluation of equipment utilization efficiency and forecast-based purchasing and selling decisions.

### SUMMARY

The following summary of the disclosure is included in order to provide a basic understanding of some aspects and features of the invention. This summary is not an extensive overview of the invention and as such it is not intended to particularly identify key or critical elements of the invention or to delineate the scope of the invention. Its sole purpose is to present some concepts of the invention in a simplified form as a prelude to the more detailed description that is presented below.

Embodiments disclosed herein provide financial and operational visibility to a healthcare organization regarding each individual asset employed in the organization. Disclosed embodiments also provide complete transparency into capital equipment performance throughout its entire lifecycle. Employing the disclosed embodiments improves forecasting of capital needs based on predictive analytics. Moreover, by providing transparency into the equipment performance, better decisions regarding replacement can be made.

Disclosed embodiments provide systems and methods for evaluating medical equipment. Aspects of disclosed embodiments provide solutions for hospitals to appraise, value, negotiate, resell and deliver their preowned or excess medical equipment to a wide array of buyers on a global platform.

Disclosed aspects include a system for determining market value of medical equipment, a computer-implemented method for determining market value of medical equipment, and a non-transitory machine-readable medium having instructions stored therein, which when executed by a processor, cause the processor to estimate market value of a medical equipment.

Disclosed embodiments may provide estimated trade value of each particular medical equipment, to be used by organizations such as hospitals and clinics considering purchasing or selling equipment, leasing companies that may be interested in determining residual value of each equipment, service and outsourcing companies interested in, e.g., pricing their services, group purchasing organization, etc.

### BRIEF DESCRIPTION OF THE DRAWINGS

The accompanying drawings, which are incorporated in and constitute a part of this specification, exemplify the embodiments of the present invention and, together with the description, serve to explain and illustrate principles of the invention. The drawings are intended to illustrate major features of the exemplary embodiments in a diagrammatic manner. The drawings are not intended to depict every feature of actual embodiments nor relative dimensions of the depicted elements, and are not drawn to scale.

FIG. 1 illustrates an overview of a marketplace screenshot, in accordance with one embodiment of the present invention.

FIG. 2 illustrates lifecycle optimization platform in accordance with one embodiment of the present invention.

FIG. 3 illustrates a graph of a value optimization model, in accordance with one embodiment of the present invention.

FIG. 4 illustrates a seller valuation range examples screenshot, in accordance with one embodiment of the present invention, in accordance with one embodiment of the present invention.

FIG. 5 illustrates a seller price gauge display screenshot, in accordance with one embodiment of the present invention.

FIG. 6 is a graph illustrating the use of the market value estimator to enable determination of equipment disposition and arbitrage opportunity, according to an embodiment.

FIG. 7 illustrates a snapshot of a dashboard, including a representation of inputs, according to an embodiment.

FIG. 8 is a general schematic illustrating the major components of the system according to an embodiment.

FIG. 9 is another general schematic illustrating the major components of the system according to an embodiment.

FIG. 10 is a flow chart illustrating a method that may be performed by the system to calculate profitability of a medical equipment, according to an embodiment.

FIG. 11 is a schematic illustrating the integration feature of the system, according to an embodiment.

FIG. 12 is a screenshot of a user dashboard according to an embodiment.

### DETAILED DESCRIPTION

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention however the order of description should not be construed as to imply that these operations are necessarily order dependent. In particular, these operations need not be performed in the order of presentation. Moreover, different features may be highlighted in different embodiments, but should not be construed as limited only to the embodiment within which they are disclosed. Indeed, the features may be “mixed and matched” with different embodiments, as one finds different benefits.

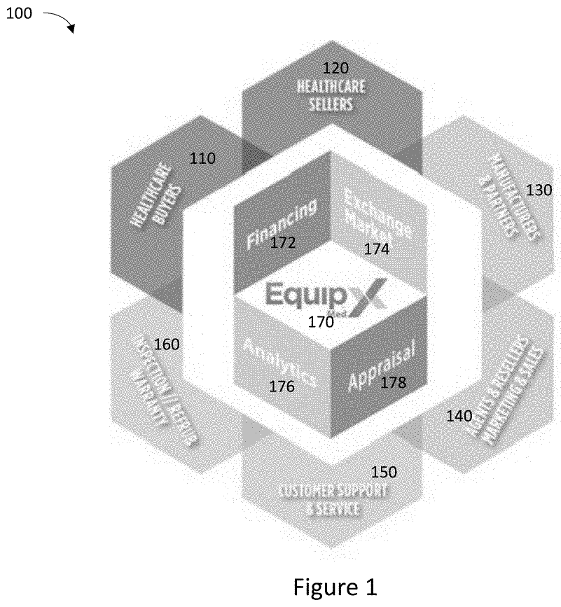

FIG. 1 illustrates an overview of a marketplace 100 for medical equipment, in accordance with one embodiment of the present invention. The system 170 operates within the marketplace 100 using a plurality of modules, and provides access to a plurality of different entities. The entities may include a plurality of healthcare buyers 110, a plurality of healthcare sellers 120, a plurality of manufacturers and partners 130, a plurality of agents, resellers, marketing and salespersons 140, a customer support and service 150, an inspection and repair warranty 160. The overall system 170 may include a plurality of modules, including financing module 172, an exchange market module 174, analytics module 176 and an appraisal module 178. The modules operate to provide the entities analysis based on data input, which helps in making capital equipment decisions.

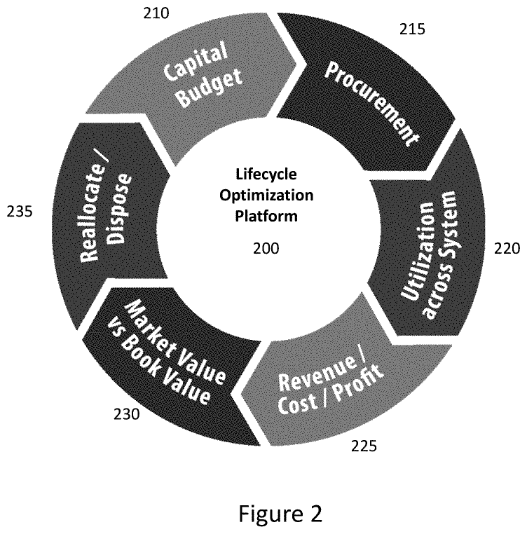

FIG. 2 illustrates an embodiment of a lifecycle optimization platform. As the lifecycle is circular, the processing may begin at any part of the cycle, but for illustration this description begins at the capital budget module 210. The capital budget module provides accurate use projection for each capital equipment, including financial performance data. The capital budget module includes a budget simulator module that enables a user to simulate various scenarios using decision entries such as: reallocation or relocation of the equipment, sale of the equipment, and performing life extending maintenance. The procurement support module 215 includes an equipment valuation calculator, which will be described in more details below. The procurement support module 215 also includes a return on investment (ROI) calculator and a market sale price module. The utilization module 220 includes utilization calculator that provides actual utilization of each capital equipment deployed in the system. The utilization module also provides use comparison of various equipment and use trends by equipment type.

The revenue module 225 includes revenue calculator that provides real time revenue generated by each deployed asset. The revenue module 225 also provides the operating cost of each asset and profitability by asset and category of assets. Further, the profit margins are calculated at the equipment, department and procedure levels. The value module 230 provides an analysis of market versus book value of each asset. It includes market price estimator and generates an optimal point of sale indicator. The disposition module 235 also employs the market value estimator and generates a trade-in comparison. The disposition module also includes a financial simulator which enables calculating outcomes for different disposition scenarios. Additionally, the disposition module also incorporates a marketplace for online purchase and sell of medical equipment.

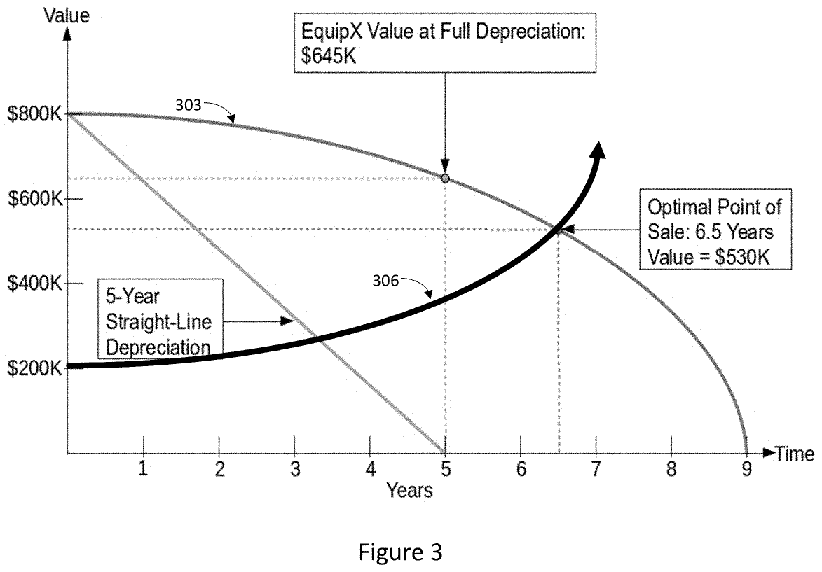

FIG. 3 illustrates a graph of a value optimization model, in accordance with one embodiment of the present invention. The value optimization model may include a time X-axis and a money value Y-axis. In this embodiment a straight line depreciation is used, illustrated by the straight line from $800K value (arbitrarily chosen) and ending at 5 years. The market value estimator 230 (to be described below) is used to generate estimated market value over time and generate the down-sloping curve 303. As can be seen, the calculated market value differs from the book value that is indicated by the depreciation line. Additionally, revenue module 225 calculates the operating costs of the equipment, which is illustrated by up-sloping curve 306. According to this example, the optimal point of sale is defined as the intersection of the market value curve 303 and operating cost curve 306. This may be considered as an arbitrage point, as from accounting perspective, the organization owns a fully depreciated assets, which has zero value on the books. However, the market value of the equipment is much higher, so that in effect the system of this embodiment uncovered previously unrecognized value within the organization.

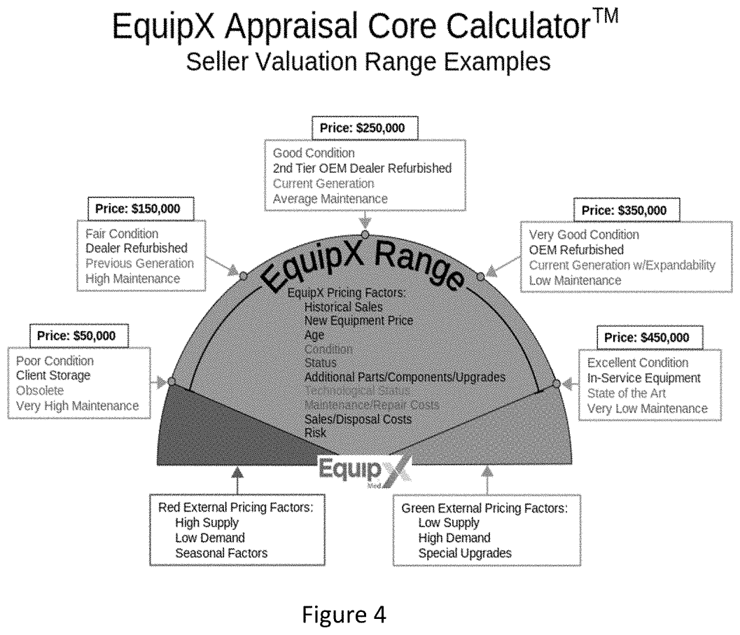

FIG. 4 illustrates a graph of seller valuation range screenshot, in accordance with one embodiment of the present invention. The example of FIG. 4 illustrates the operation and benefits of the market value estimator 230. The market value estimator receives data regarding various factors, assigns weights to each factor, and calculate a market price therefrom. The factors may include historical sales prices, the new equipment price, the age of the equipment, the condition of the equipment (as selected by the user), the status of the equipment (operational, in storage, undergoing refurbishment, etc.), additional parts components and/or upgrades conveyed with the equipment, technological status of the equipment, maintenance costs, disposition costs, and risk factors. The pricing examples illustrated in FIG. 4 are fictitious and used for illustration only. The values generated by the market value estimator 230 may be used to generate graph 306 shown in FIG. 3.

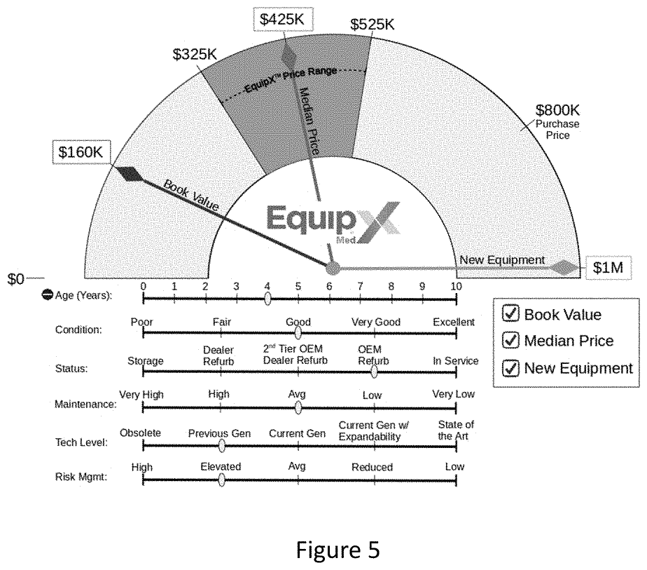

FIG. 5 illustrates a seller price gauge display screenshot, in accordance with one embodiment of the present invention. The seller price gauge display enables a potential seller to enter various factors and generate an estimated market price using the market value estimator 230. The seller price gauge display also enables the user to see how different factors may affect the estimated market price, so as to make decision regarding, e.g., maintenance, upgrades, refurbishment, and sell of the equipment.

In this example, discrete values are provided for each factor for the user to select. Once these discrete values are selected, the market value estimator 230 applies variable weights to each of the factors and then calculates the market value. In this example the factors include age, condition, status, maintenance, technology level, and risk. In the example of FIG. 5 the market value price is displayed in the form of a semi-circular speedometer style gauges, with a first dial indicating the current book value of the equipment and a second dial indicating the calculated market value of the equipment. Whenever the calculated market value of the equipment is to the right, i.e., higher than the book value dial, an arbitrage opportunity exists.

Also, in FIG. 5 the factors are presented as digital slides (selectors or dials) having discrete stations for the user to select presented values by positioning the slides or dials on the selected values. In this manner, as the user changes any selected value, the user is able to immediately see the movement of the dial on the speedometer to understand the effect of that particular selection on the market value calculation. FIG. 5 may also include a third dial which indicates the new equipment price. The user may be provided with check boxes to decide which dials to display on the speedometer.

In disclosed embodiments, the market value estimator 230 incorporates various factors and determines weights to each individual factor as follows. The actual historical sales of fundamentally similar equipment may be a factor in the calculation. In disclosed embodiments the weight applied to the historical sales is variable, and increases as the volume of sales data collected increases. Notably, for each type or model of equipment different amount of data of actual sales may be available. Thus, the weight is assigned specific to the individual equipment.

If the equipment/model under consideration is still in production, the prices of new, replacement equipment will be factored into the market value calculation. If the price of new equipment has increased over time, this will have a positive impact on the price of the Seller's equipment. If the price of new equipment has decreased over time, this will have a negative impact on the price of the Seller's equipment. A percentage scale affecting the market value price will be applied to the equipment based upon the price of new/comparable equipment. In one embodiment the weights may be −15%; −10%; −5%; 0%; 5%; 10%; 15%.

The equipment's age may be a factor in the market value calculation. The newer the equipment, the higher the market value price. Actual age (in years) may be used as a factor in the market value calculation, and an applied weight may be changed to reflect the age. For example, higher weight at the edges (newer or very old equipment, and lower weight at the center reflecting average age).

Another factor may be equipment status. Equipment in working condition will be assigned a higher weight than equipment in non-working condition. Unused equipment in storage will be assigned a weight based upon its status and length of time in storage. A discrete scale may be applied, for example: 1=equipment in client storage; 2=dealer refurbished equipment; 3=2nd tier OEM dealer refurbished equipment; 4=OEM refurbished equipment; 5=fully functional in-service equipment.

A further factor may be the equipment's condition, as selected by the user. That is, the user would be provided a discrete scale selection and the input from the user would be used for the weight. The equipment will be assigned a factor based on its condition, e.g., using the scale: 1=Poor; 2=Fair; 3=Good; 4=Very Good; 5=Excellent.

Another factor may be the technical status of the equipment. Obsolete or previous generation equipment will have a limited test menu. Current generation or state of the art equipment will have an expanded test menu. The equipment will be assigned a factor based on its technological status using a scale, e.g., 1=Obsolete; 2=Previous Generation; 3=Current Generation; 4=Current Generation with Expandability; 5=State of the Art.

Maintenance and repair costs may be considered as a percentage of the cost of the equipment. The factor increases inversely with the maintenance cost, i.e., the less it costs to maintain, the higher the factor value. This may also be assigned on a scale of discrete values, e.g., 1=Very High Maintenance Costs; 2=High Maintenance Costs; 3=Average Maintenance Costs; 4=Low Maintenance Costs; 5=Very Low Maintenance Costs.

Some equipment may include additional parts or upgrades, some by the equipment manufacturer and some by non-OEM aftermarket suppliers. If a piece of equipment has manufacturer (OEM) upgrades or parts, it will result in an increase in the market value price. A non-OEM upgrades or parts may affect the market value price negatively.

Generally, sale or disposal of the equipment would incur transaction costs, which may be factored into the market value price. The disposal costs may be selected by the user using a discrete scale expressed as a percentage of the market value sale price.

Purchase of used equipment entails assuming risks. The risk may be scaled based on the selling situation. For example, an OEM certified equipment offered for sale by a major hospital may be assigned a low risk, while sale of equipment at an auction may be assigned a high risk. Again, the factors would be presented to the user as discrete values for selection, e.g., 1=High Risk; 2=Elevated Risk; 3=Average Risk; 4=Reduced Risk; 5=Low Risk.

In some embodiments, each of the factors are presented to the user as discrete values for selection. The entered values are then used with assigned weights to generate market value price using the expression:

Price=IP−α*A−β*S−δ*C−ε*T−ω*M−π*P,

Wherein IP is the equipment initial price, A is the equipment age, S is the equipment status, C is the equipment condition, T is the technological status, M is the equipment maintenance costs factor (using scale values, not actual dollar costs), and P is additional parts factor value. The weight variables α, β, δ, ε, ω, π may be determined by historical data and are assigned different values depending on the equipment type/model. Also, in some embodiments the market value is provided as a range rather than a single value. The range is calculated as plus minus the market value price obtained from the expression provided above. That is, for an example where the percentage chosen is 5%, the range is from (price −5%) to (price +5%).

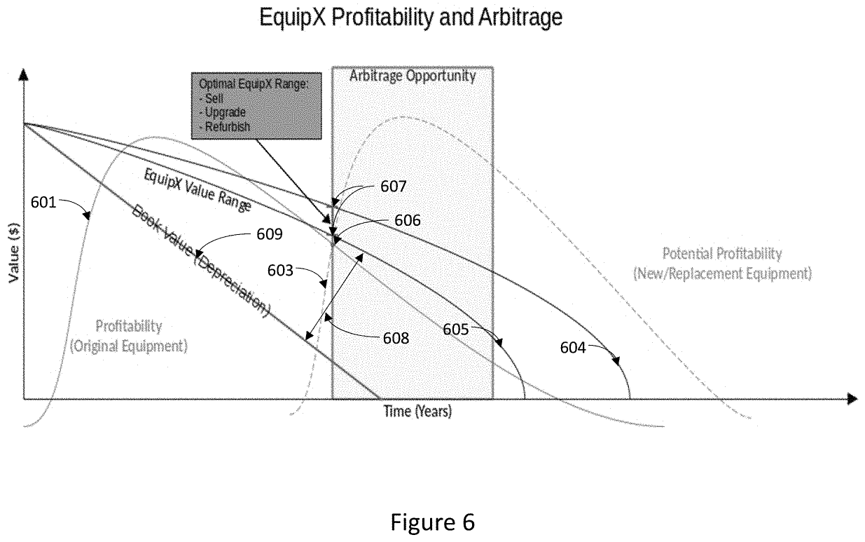

FIG. 6 is a graph illustrating the use of the market value estimator to enable determination of equipment disposition and arbitrage opportunity, according to an embodiment. In FIG. 6 the x-axis expresses time in years, while the y-axis expresses value, e.g., in dollars or relative scale. This graph shows the optimal time to sell or upgrade/refurbish the equipment. Curve 601 indicates the profitability of the equipment over time. Over time, the profitability will begin to decrease as equipment ages and maintenance costs increase. As noted above, the revenue module 225 can evaluate the potential profitability of new or upgraded/refurbished equipment indicated as curve 603 in dashed line. The market value calculator is then used to determine upper and lower estimates for the market value of the equipment. The system then identifies when is the best time to perform the sale/upgrade of the equipment in order to maximize profits. This is represented on the graph by the point 606 where the profitability curve and potential profitability curve cross each other. The price at which the equipment might be sold is indicated by the two points 607, where the sell time crosses the two market value range curves.

FIG. 6 also illustrates the arbitrage opportunity calculated by the system. The arbitrage opportunity is the spread (or area) between the book value curve 609 and the curves of the market value 604 and 605. This is indicated in FIG. 6 by the double-headed arrow 608. This value is not recognized by the institution as the accounting books only show the depreciated value. Note that the variability between the high and low market value curves increase over time due to changes in the market value pricing factors, e.g., equipment condition deteriorates, technological obsolescence increases, the price of new/comparable equipment changes, etc.

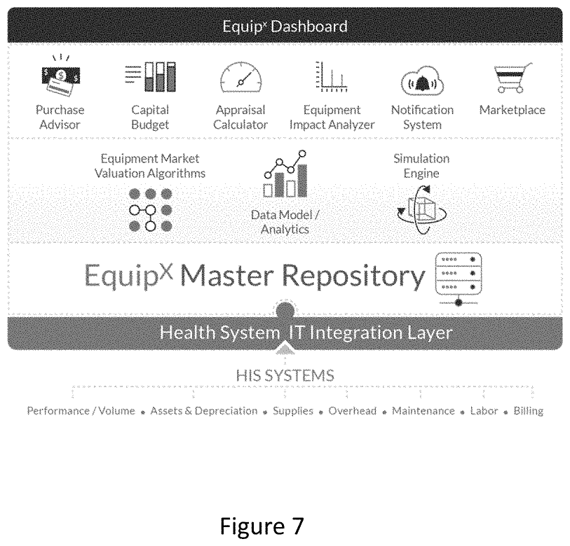

FIG. 7 illustrates a snapshot of a dashboard, including a representation of inputs, according to an embodiment. As shown in the bottom of FIG. 7, various inputs may be provided to the system to be used in various calculations. The inputs may include volume of procedures performed by the equipment, list of assets and depreciation values, costs of supplies used with the equipment, overhead costs associated with the equipment, maintenance cost of the equipment, labor costs associated with the equipment, and all billings associated with the equipment (to determine revenue attributed to the equipment). The input data is assigned to the various medical equipment deployed. The dashboard enables the user to activate the various modules of the system. The various modules may include a purchase advisor which may provide purchasing recommendations based upon, e.g., the output of the market value estimator, which is shown as appraisal calculator in FIG. 7. The equipment impact analysis module can be used to determine profitability of each equipment, the impact of an upgrade or refurbishment, etc. The marketplace module can be used to place equipment for sale or to purchase equipment.

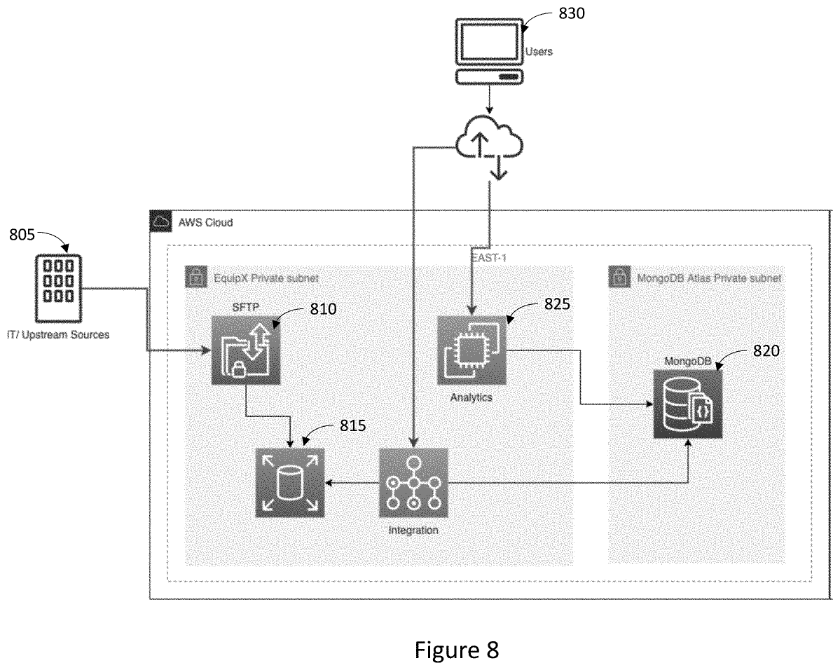

FIG. 8 is a general schematic illustrating the major components of the system according to an embodiment. Various outside sources 805 may upload data into the system. For example, the sources may include manufacturers uploading new equipment pricing, used equipment marketplace uploading actual sales data, service companies uploading maintenance price sheets, etc. The data may be sent to the cloud using the Secure File Transfer Protocol 810 to be analyzed and stored by data processor 815. All data, analytics, calculation results, etc., may be stored in the database 820. Analytics processor 825 performs the analysis to provide user 830 with the results and recommendations, as disclosed herein.

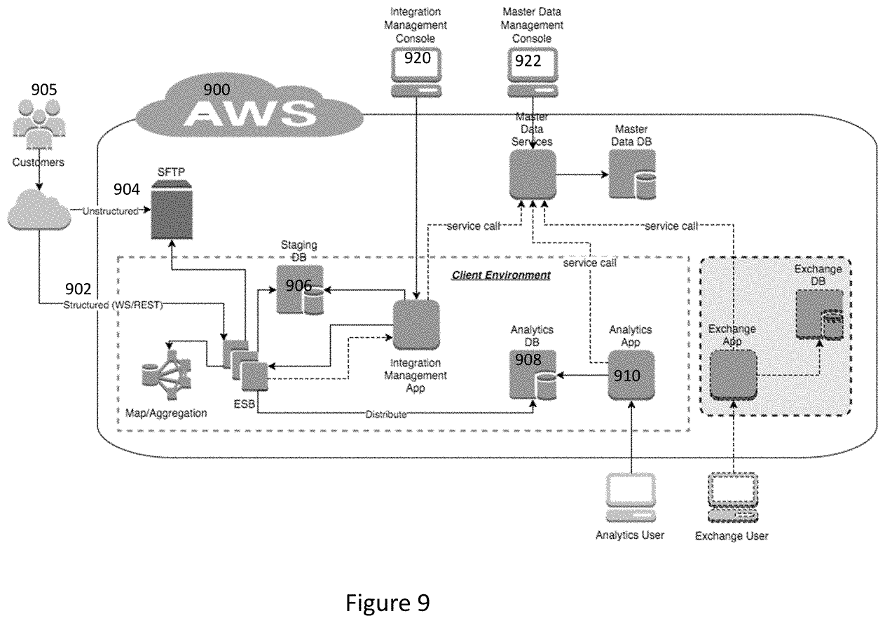

FIG. 9 is another general schematic illustrating the major components of the system according to an embodiment. The entire system may reside in the cloud 900 and be provided to users 905 as a software as a service (SaaS). Data may enter the system as structured 902 or unstructured 904 data. The data is organized and stored in staging database 906. Analytics modules 910 may access and store data in analytics database 908. The entire system is managed by integration management console 920 and master data management console 922.

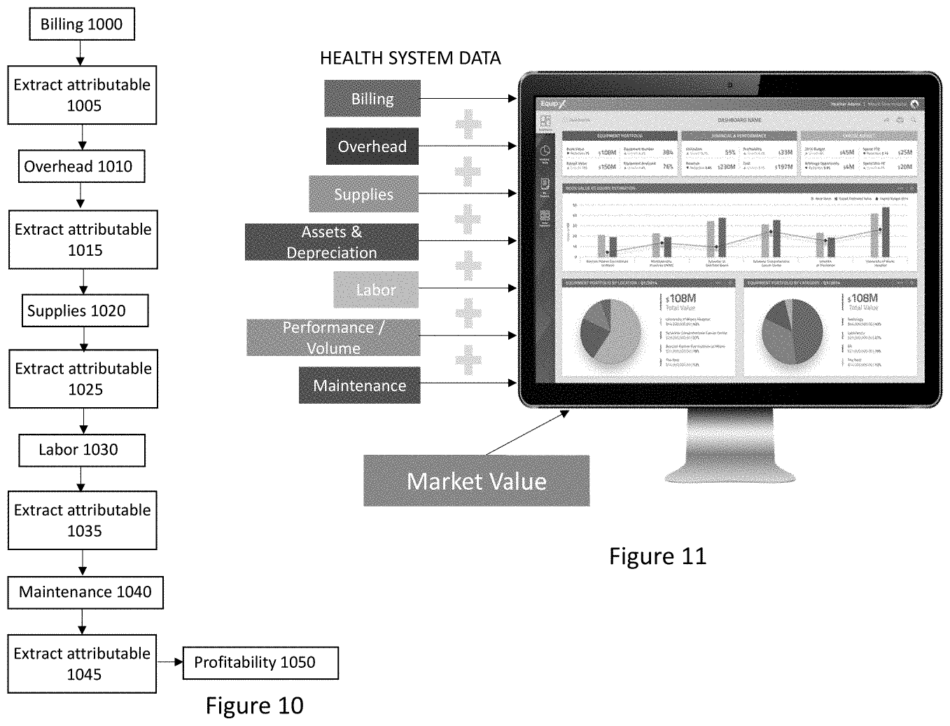

FIG. 10 is a flow chart illustrating a method that may be performed by the system to calculate profitability of a medical equipment, according to an embodiment. At 1000 the system receives billing information that includes bills sent out by the institution to bill for various medical services. At step 1005 the system extracts the amount of each bill which is attributable to the particular medical equipment. At 1010 the system receives data of the overhead expense of the facility. At 1015 the system extracts the overhead that is attributable to the operation of the medical equipment. For example, a lease payment for the entire facility cannot be applied directly to the particular equipment, but must be extracted to include only cost associate with the equipment, e.g., a ratio of size of the room where the equipment is placed to the size of the entire building. At 1020 the system receives data reflecting payments made for purchasing supplies. At 1025 the system utilizes its knowledge database to decipher the type of supplies used by the particular equipment to extract only the cost of supplies attributable to those supplies. At 1030 the system receives labor expense data. At 1035 the system utilizes its knowledge database to determine the type of labor that is attributable to the equipment. For example, labor costs of an x-ray technician may be attributable to an x-ray machine, but surgeons' labor expense may not be. At step 1040 the system receives maintenance data and at 1045 the system utilizes its knowledge base to extract only maintenance attributable to the specific equipment. Using all the extracted data, the system at 1050 can calculate the profitability of the particular equipment.

An example of the system integration is illustrated in FIG. 11. The system receives various data from the health care system and utilizes various modules to extract appropriate data for each particular equipment and therefrom generates an estimated trade value for each equipment, time to replace the equipment, residual value of leased equipment, potential fair market price for a group purchasing organizations (GPO), etc. The input may include billing information, overhead costs, supplies costs, assets and depreciation, labor costs, performance and utilization and maintenance costs. As described herein, the system extracts only the data relevant to a particular equipment and assigns to each individual medical equipment the portion attributable to that particular equipment.

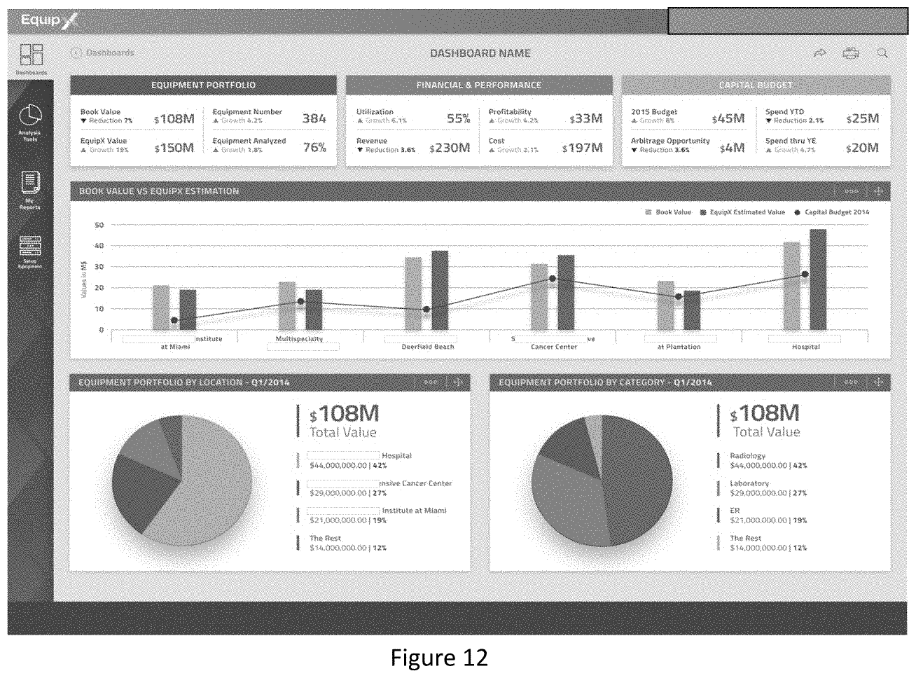

The system then displays a dashboard for the user to enable the user to understand the financial effect of each particular medical equipment on the performance of the entire organization, as illustrated in FIG. 12. As shown in FIG. 12, the system can be used for optimization of the utilization of the equipment. This may also be done using simulations of various scenarios for each equipment. The system may present data by assigning various equipment to different departments to determine the efficiency at each department. The data is also visualized by each medical center by aggregating all the equipment operating within that medical center.

The phrase “in one embodiment” is used repeatedly. The phrase generally does not refer to the same embodiment, however, it may. The terms “comprising”, “having” and “including” are synonymous, unless the context dictates otherwise. While the present invention has been related in terms of the foregoing embodiments, those skilled in the art will recognize that the invention is not limited to the embodiments described. The present invention may be practiced with modification and alteration within the spirit and scope of the appended claims. Thus, the description is to be regarded as illustrative instead of restrictive on the present invention.

While this invention has been discussed in terms of exemplary embodiments of specific materials, and specific steps, it should be understood by those skilled in the art that variations of these specific examples may be made and/or used and that such structures and methods will follow from the understanding imparted by the practices described and illustrated as well as the discussions of operations as to facilitate modifications that may be made without departing from the scope of the invention defined by the appended claims.

1. A system for determining market value of medical equipment, comprising:
a processor;
a memory;
an interface module for receiving, from a user device, factors data associated with an individual equipment;
a data gathering module for gathering historical equipment sales data on a plurality of medical equipment; and
a processing module configured to:
present on the user interface module a plurality of factors, each factor having discrete selection for factors data entry;
determine variable weights for each of the factors;
received the factors data from the interface module;
apply the weights to each of the factors data as entered by the user to generate weighted factors;
add all of the weighted factors; and,
display on the interface module an estimated market price.

2. The system of claim 1, further comprising a maintenance cost module determining maintenance cost of each individual equipment, and wherein the processing module is further configured to determine an intersection of the estimated market price and maintenance cost and present on the interface module the intersection as optimal sale point.

3. The system of claim 1, further comprising a profitability module determining profitability of each individual equipment and potential profitability of replacement equipment, and wherein the processing module is further configured to determine an intersection of the profitability and potential profitability and present on the interface module the intersection as optimal sale point.

4. The system of claim 3, wherein the processing module is further configured to determine an intersection of timeline at the optimal sale point and the estimated market price to provide estimated market price at the optimal sale point.

5. The system of claim 1, wherein the processing module is further configured to calculate a spread between equipment book value and the estimated market price and provide the results as potential arbitrage.

6. The system of claim 1, wherein the processing module is further configured to display on the interface module a circular speedometer and having a speedometer dial indicating the estimated market price.

7. The system of claim 6, wherein the processing module further displays a second dial indicating book value of the equipment.

8. The system of claim 6, wherein the processing module is further configured to display on the interface module a plurality of selectors, each assuming a plurality of discrete position, each selector corresponding to one of the factors.

9. The system of claim 8, wherein the processing module is further configured to change positioning of the speedometer dial according to each dial selector position change.

10. The system of claim 1, wherein the processing module is further configured to increased a weight applied to the historical equipment sales data of the equipment according to sample size of the historical equipment sales data for the equipment.

11. A non-transitory machine-readable medium having instructions stored therein, which when executed by a processor, cause the processor to estimate market value of a medical equipment by performing operations comprising:
project on a monitor a user interface enabling a user to select discrete values for a plurality of pricing factors;
receive from the user a plurality of selections of discrete values;
receive a sample of historical sales prices for the medical equipment;
determining a weight to apply to the historical sales price, wherein the value of the weight increases with the size of the sample;
apply the weight to the historical sales price to generate a weighted historical price;
calculate an individual variable weight to be applied to each of the discrete values;
apply the individual variable weight to each of the discrete values to generate weighted discrete values;
using the weighted historical price and the weighted discrete values to generate an estimated market price.

12. The non-transitory machine-readable medium of claim 11, wherein the processor further performs the operations comprising: generating an estimated market range by applying a positive and negative percentage to the estimated market price.

13. A computer-implemented method for determining market value of medical equipment, comprising the steps:
projecting on a monitor a user interface enabling a user to select discrete values for a plurality of pricing factors;
receiving from the user a plurality of selections of discrete values;
receiving a sample of historical sales prices for the medical equipment;
determining a weight to apply to the historical sales price, wherein the value of the weight increases with the size of the sample;
applying the weight to the historical sales price to generate a weighted historical price;
calculating an individual variable weight to be applied to each of the discrete values;
applying the individual variable weight to each of the discrete values to generate weighted discrete values;
using the weighted historical price and the weighted discrete values to generate an estimated market price.

14. The non-transitory machine-readable medium of claim 12, wherein the processor further performs the operations comprising: determining maintenance cost of each individual equipment, and determining an intersection of the estimated market price and maintenance cost and present on an interface the intersection as optimal sale point.

15. The non-transitory machine-readable medium of claim 14, wherein the processor further performs the operations comprising: determining profitability of each individual equipment and potential profitability of replacement equipment, and determining an intersection of the profitability and potential profitability and present on the interface the intersection as optimal sale point.

16. The non-transitory machine-readable medium of claim 12, wherein the processor further performs the operations comprising: calculating a spread between equipment book value and the estimated market price and providing the results as potential arbitrage.

17. The computer-implemented method of claim 13, further comprising the steps: determining maintenance cost of each individual equipment, and determining an intersection of the estimated market price and maintenance cost and present on an interface the intersection as optimal sale point.

18. The computer-implemented method of claim 13, further comprising the steps: determining profitability of each individual equipment and potential profitability of replacement equipment, and determining an intersection of the profitability and potential profitability and present on the interface the intersection as optimal sale point.

19. The computer-implemented method of claim 18, further comprising the steps: calculating a spread between equipment book value and the estimated market price and providing the results as potential arbitrage.

20. The computer-implemented method of claim 18, further comprising the steps: receiving billing information and extracting attributable amounts relating to the individual equipment to calculate the profitability of each of the individual equipment.
